(19) United States
(12) Patent Application Publication
(10) Pub. No.: US 2015/0183146 A1
(43) Pub. Date: Jul. 2, 2015

(54) APPARATUS AND METHOD FOR FORMING INTERIOR PART OF VEHICLE AND INTERIOR PART MANUFACTURED BY THE SAME

(71) Applicants: Hyundai Motor Company, Seoul (KR); Kia Motors Corporation, Seoul (KR); Han II E-Hwa Co., Ltd., Seoul (KR)

(72) Inventors: Y Tae KIM, Yongin-si (KR); Ho Jae LEE, Cheonan-si (KR); Chi Weon YOON, Asan-si (KR)

(73) Assignees: Hyundai Motor Company, Seoul (KR); Kia Motors Corporation, Seoul (KR); Han II E-Hwa Co., Ltd., Seoul (KR)

(21) Appl. No.: 14/480,474

(22) Filed: Sep. 8, 2014

(30) Foreign Application Priority Data
Dec. 30, 2013 (KR) 10-2013-0166692

(51) Int. Cl. B29C 45/14; B32B 15/08; B32B 27/06; B32B 3/30

(52) U.S. Cl. CPC B29C 45/14065; B29C 45/1418; B32B 3/30; B32B 15/08; B32B 27/06; B29C 2045/14155; B29K 2705/00

(57) ABSTRACT

An apparatus and a method for forming an interior part of a vehicle may include a first mold forming a cavity when being combined with a second mold, a core installed in the first mold to be moved forwards and rearwards and configured to approach the second mold when being moved forwards, and a resin supply line formed in an interior of the core, for supplying a resin into a cavity adjacent to an upper end of the core, wherein a product in which a metal part and a molded part may be integrally formed may be formed by setting metal foil which may be a material of the metal part to the core, moving the core forwards, and injecting a resin which may be a material of the molded part to a rear surface of the metal foil.

### CROSS-REFERENCE TO RELATED APPLICATION

The present application claims priority to Korean Patent Application No. 10-2013-0166692 filed on Dec. 30, 2013, the entire contents of which is incorporated herein for all purposes by this reference.

### BACKGROUND OF THE INVENTION

1. Field of the Invention

The present disclosure relates to an apparatus and a method for forming an interior part of a vehicle. More particularly, the present disclosure relates to an apparatus and a method for forming an interior part of a vehicle by which an external appearance of an interior part such as a door step can be improved and the number of manufacturing processes can be reduced.

2. Description of Related Art

In general, a door step or step plate of a vehicle prevents fine scars or scratches by shoes when a passenger gets on or gets off.

As shown in FIG. 1, an existing door step is finished by assembling a metal part 1 and a molded part 2, and the metal part 1 is manufactured through a press process and the molded part 2 is manufactured through an injection-molding process.

That is, the existing door step is finished by assembling the metal part (or a metal foil product) partially at one side of the plastic molded part 2, that is, at a portion of the molded part 2 mainly contacting a passenger when the passenger takes a ride or gets off.

When the metal part 1 and the molded part 2 are assembled, they are brought into a line contact instead of a surface contact but due to noise and gaps, and as shown in FIG. 1, an interior of the assembled parts has a space of a predetermined size. Accordingly, the material of the metal part may be dotted.

The weight of the existing door step increases when the thickness of the metal part increases to improve strength, and since the two parts (the metal part and the molded part) are formed respectively and then finished via assembly, manufacturing costs increase due to an increase in the number of processes.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an apparatus and a method of forming an interior part of a vehicle by which quality of an injection-molded product can be improved and manufacturing costs can be reduced by eliminating an empty space between a metal part and a molded part and reducing the number of assembly processes.

In an aspect of the present disclosure, an apparatus for forming an interior part of a vehicle, may include a first mold forming a cavity when being combined with a second mold, a core installed in the first mold to be movable forwards and rearwards and configured to approach the second mold when being moved forwards, and a resin supply line formed in an interior of the core, for supplying a resin into a cavity adjacent to an upper end of the core, wherein a product in which a metal part and a molded part are integrally formed is formed by setting metal foil which is a material of the metal part to the core, moving the core forwards, and injecting the resin which is a material of the molded part to a rear surface of the metal foil.

A vacuum supply line for transferring external vacuum to an upper end of the core is formed in the core to prevent separation of the metal foil held at the upper end of the core.

A setting guide formed at a portion adjacent to a periphery of the core at a height higher than an upper end of the core is provided in the first mold such that the metal foil held at the upper end of the core is located at a proper location.

The second mold may have a rounded structure by which a periphery of the metal foil attached to a skin of a cavity of the second mold by an injection-molding pressure when the resin is injection-molded.

The second mold may have a convexo-concave structure for transferring a predetermined shape to a skin of the metal foil.

In further another aspect of the present invention, a method of forming an interior part of a vehicle, may include a first step of setting metal foil cut to a predetermined size to an upper end of a core of a first mold, a second step of primarily forming the metal foil by combining the first mold and a second mold and moving the core forwards toward the second mold, and a third step of supplying a resin to a rear surface of the metal foil and moving the core rearwards to form a molded part in a cavity between the first mold and the second mold and attaching the metal foil to a cavity skin of the second mold by an injection molding pressure of the resin to secondarily form the metal part, wherein the molded part is integrally formed on a rear surface of the metal part.

In the first step, the metal foil held at an upper end of the core is prevented from being separated when the core is moved forwards by transferring external vacuum to the rear surface of the metal foil through a vacuum supply line of the core.

In the first step, the metal foil held at an upper end of the core is located at a proper location through a setting guide of the first mold formed at a height higher than an upper end of the core.

In the third step, a periphery of the metal foil is attached to the cavity skin of the second mold to be bent to have a curved shape.

In another aspect of the present invention, an interior part of a vehicle, may include a metal part and a molded part integrally formed with a rear surface of the metal part, wherein a periphery of the metal part is bent along a curved shape of a groove recessed between a central portion and a side portion of the molded part and is attached to a surface of the groove.

The metal part may have a stamp having a predetermined shape on a skin thereof.

The apparatus and method of forming an interior part of a vehicle according to the present disclosure has the following effects.

The satisfaction level of consumers can be improved by reducing generation of dots due to an external impact.

Manufacturing costs can be reduced by reducing the number of processes.

The weight of a metal part can be reduced by reducing the thickness of the metal part.

The apparatus and method according to the present disclosure can be applied to various interior parts of vehicles including door steps.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing a sectional structure of a door step according to the related art.

FIG. 2 is a view showing an apparatus and a method for forming an interior part of a vehicle according to an exemplary embodiment of the present disclosure.

FIGS. 3 to 6 are views showing main parts of the apparatus for forming an interior part of a vehicle according to the exemplary embodiment of the present disclosure.

FIG. 7 is an exemplary view showing a door step of a vehicle manufactured according to the exemplary embodiment of the present disclosure.

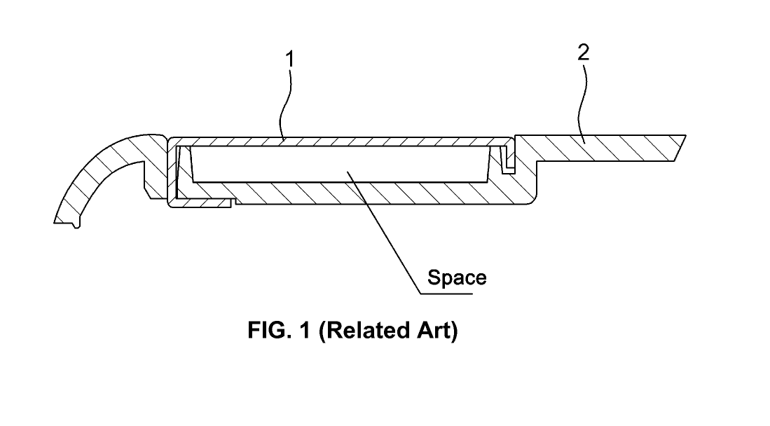

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, the present disclosure will be described in detail so that those skilled in the art to which the present disclosure pertains can easily carry out the present disclosure.

The present disclosure is adapted to form a molded part and a metal part at the same time when a door step in which the metal part and the molded part are combined with each other, and eliminates an empty space between two parts and reduce the number of assembly processes by forming the metal part and the molded part in one mold.

Accordingly, the present disclosure inserts metal foil which is the material of a metal part into an injection mold and fixes the metal foil, forms the metal foil in a predetermined form in the injection mold and transfers letters and patterns on skin (an outer surface) of the metal foil, and forms a molded part after primarily forming the metal foil and secondarily forms the metal foil, increasing forming performance of the product.

The manufactured product, that is, the door step is an integrally molded product whose skin is formed of aluminum and whose base is formed of plastic. When viewed from the top, the center of the door step corresponds to a metal and a side thereof corresponds to a molding material.

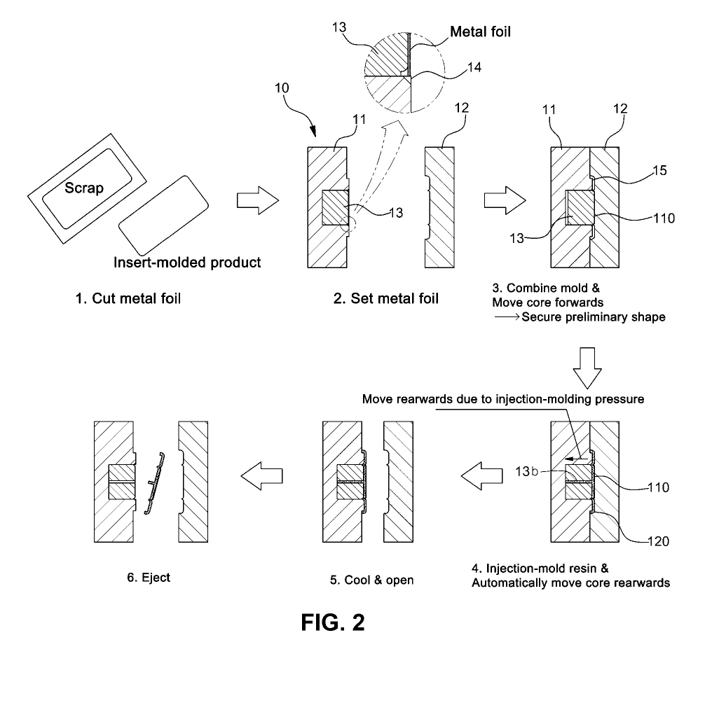

Here, the apparatus and method of forming the product (interior part) in which a metal part and a molded part are combined, such as a door step, will be described with reference to FIGS. 2 to 6.

As shown in FIG. 2, the process of forming a door step according to the present disclosure includes process of cutting metal foil, setting and vacuum suctioning the metal foil, securing a preliminary shape of a metal part by combining a mold and moving a core forwards, forming a molded part and secondarily forming the metal foil, cooling and opening the mold, and ejecting (releasing) a product.

First, metal foil which is the material of a metal part 110 is cut into a plate shape having a predetermined size and is properly introduced into a mold 10.

Then, the metal foil is set to be positioned on a core 13 of a first mold 11, and the metal foil is fixed to the core 13 in the mold 10 through vacuum suctioning when the core 13 for forming the metal foil is moved forwards so as not to be separated.

Here, the mold 10 includes a first mold 11 and a second mold 12 which may be combined with each other and opened, and includes a core 13 installed in the first mold 11 to be moved forwards and rearwards. The core 13 moves from the first mold 11 toward the second mold 12 to protrude into a cavity 15 between the first mold 11 and the second mold 12 when being moved forwards, and returns into the first mold 11 when being moved rearwards.

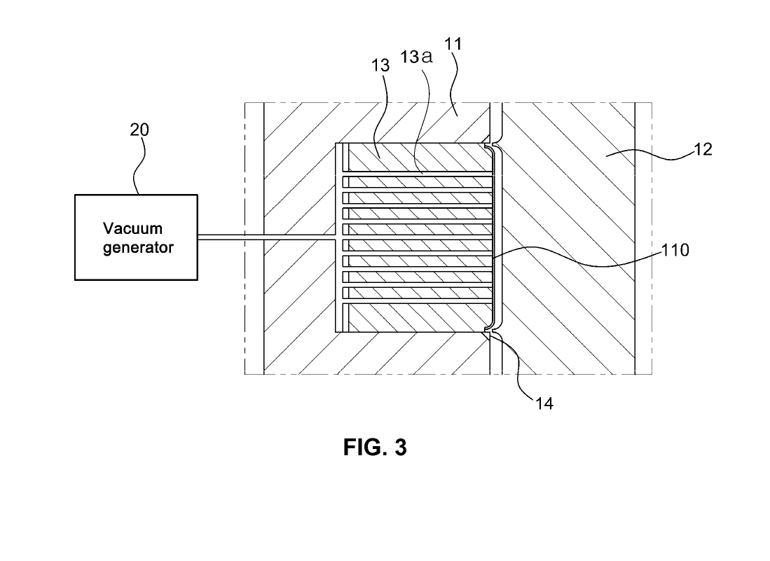

Referring to FIG. 3, a plurality of vacuum supply lines 13a for supplying vacuum to a rear surface of the metal foil held at an upper end of the core 13 are formed within the core 13, and the vacuum supply lines 13a pass through the first mold 11 from an external vacuum generator 20 to transfer the supplied external vacuum to a rear surface of the metal foil.

Thus, the plate-shaped metal foil set on the core 13 of the first mold 11 is fixed by the vacuum supplied from the interior of the core 13 when the core 13 is moved forwards so that the metal foil may be moved to the second mold 12 without being separated from the core 13.

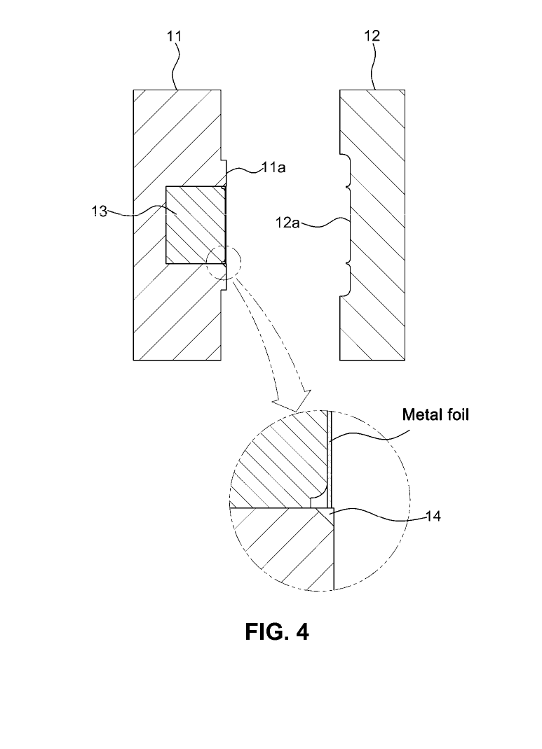

Referring to FIG. 4, a setting guide 14 for accurately guiding a setting position of the metal foil is formed at a portion (core adjoining portion) of the first mold 11 adjacent to an outskirt of the core 13.

The setting guide 14 is formed by forming the core adjoining portion of the first mold 11 at a height higher than an upper end of the core 13, and prevents the metal foil held at an upper end of the core 13 from being moved and separated from the proper position (core) by locating the metal foil inserted into the mold 10 at the proper position.

After the metal foil is properly located at an upper end of the core 13, the metal foil is primarily formed to secure a preliminary shape of the metal part 110 by combining the first mold 11 and the second mold 12 and moving the core 13 forwards.

The metal foil is pressed between the core 13 and skin 12a of a cavity of the second mold 12 by moving the core 13 while the first core 11 and the second core 12 are combined with each other to secure a preliminary shape of the metal part 110.

Then, the cavity skin 12a of the second mold 12 is provided with a structure corresponding to the shape of the skin (outer surface) of the product, and the cavity skin 11a of the first mold 11 is provided with a structure corresponding to the shape of a rear surface (inner surface) of the product.

The metal foil is primarily formed between the core 13 and the second mold 12 in the injection mold 10 when the core 13 is moved forwards, and a predetermined shape such as letters and patterns are imprinted on and transferred to the skin of the metal foil as a stamp 111 by the second mold 12.

As not shown in the drawings, letters or patterns which is to be transferred to the skin of the metal foil are formed on the cavity skin 12a of the second mold 12 as convexo-concaves.

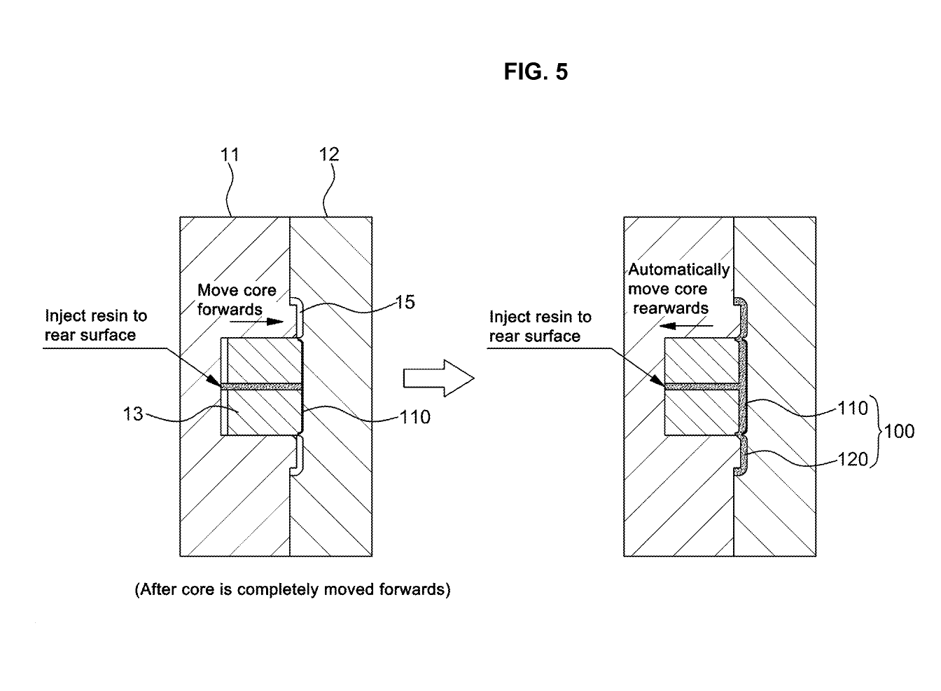

As shown in FIG. 5, after the metal foil is primarily formed, a resin is injection-molded to a rear surface of the metal foil to form a molded part 120.

That is, by completely primarily forming the metal foil by moving the core 13 forwards before forming the molded part 120 and injection-molding a resin for forming the molded part 120 to a rear side of the metal foil at an upper end of the core 13, the resin can be prevented from flowing reversely toward the skin of the metal foil, and by attaching the metal foil to the cavity skin 12a of the second mold 12 with an injection-molding pressure of the resin to seal the metal foil and the second mold 12, the final shape of the metal part 110 can be secured without an additional process.

A resin supply line 13b for supplying a resin into the cavity 15 between the first mold 11 and the second mold 12 is formed in an interior of the core 13, and although not shown, a resin supply structure connected to the resin supply line 13b to supply the resin is formed in the first mold 11.

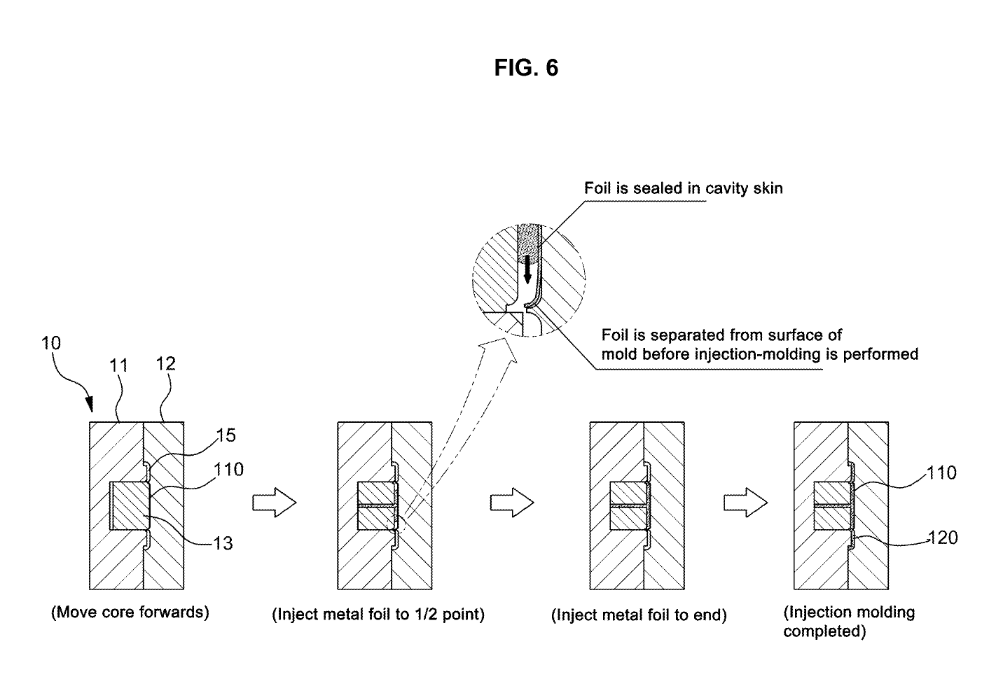

Referring to FIG. 6, after the metal foil is primarily formed as the core 13 is moved forwards, the (primarily formed) metal foil fails to be completely attached to the cavity skin 12a of the second mold 12 and is partially separated before the molded part 120 is formed.

Then, the resin is filled between the metal foil and the core 13 and the molded part 120 is gradually formed while the core 13 is automatically moved forwards by an injection-molding pressure of the resin supplied to the rear surface of the metal foil.

In detail, as the resin is injection-molded, the metal foil and the second mold 12 are entirely sealed while the metal foil is completely attached to the cavity skin 12a of the second mold 12 gradually, by gradually supplying the injection-molding pressure of the resin supplied to the rear surface of the metal foil from the center of the metal foil to a periphery of the metal foil, and accordingly, the molded part 120 is formed and the metal part 110 is secondarily formed so that the final shape of the metal part can be secured and molding performance can be enhanced.

Then, molding performance of the metal part 110 is improved and transfer performance of the letters or patterns formed on the skin of the metal part 110 is also improved.

In addition, when the core is moved rearwards by an injection-molding pressure of the resin, supply of the vacuum supplied to the rear surface of the metal foil is stopped.

That is, after the metal foil approaches the cavity skin 12a of the second mold 12, supply of vacuum to a rear surface of the metal foil is stopped and supply of the resin is started.

After the molded part 120 and the metal part 110 are completely formed, the product is cooled via a cooling process, the mold 10 is opened, and the product 100 is ejected.

In the product 100 manufactured in this way, a groove 121 is formed between a central portion 122 and a side portion of the molded part 120 to hide an end of the metal part 110, and a periphery of the metal part 110 is bent to have a curved shape, is attached to a surface of the groove 121, and is introduced into the groove 121.

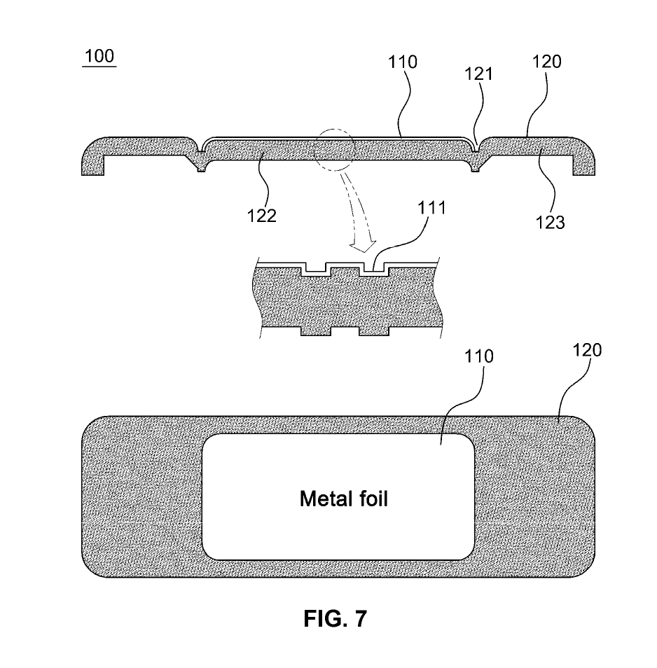

Referring to FIG. 7, the product 100 is formed by forming the metal part 110 and the molded part 120 in one mold at the same time such that an assembly process is reduced, in which case the molded part 120 acts as a bezel of the door step and the metal part 110 acts as a decoration attached to the skin of the bezel.

The product 100 includes the molded part 120, and the metal part 110 integrally formed on a surface of the central portion 122 of the molded part 120, and the periphery of the metal part 110 is bent to have a curved shape (rounded shape), is attached to a surface of one side of the groove 121 recessed on the skin of the molded part 120, and is introduced into the groove 21 such that an end of the metal part 110 cannot be viewed from the outside of the product 100 and thus a product value of the product can be improved.

A stamp 111 having a predetermined shape such as letters or patterns is concavely recessed on the skin of the metal part 110.

Although not shown, the molded part 120 formed of a polymer and the metal part 110 formed of a metal are bonded by using an adhesive when the molded part 120 is formed in the mold 10 or an adhesive is applied to a rear surface of the metal part 110 before the metal part 110 is inserted into the mold 10, or a resin is injected into an aperture when a polymer resin is injected by machining the aperture into which a resin may be injected on a rear surface of the metal foil to increase coupling efficiency of the molded part 120 and the metal part 110 and integrally form the molded part 120 and the metal part 110.

For example, the metal foil is introduced into the mold 10 and the rear surface of the metal foil is machined to form a plurality of apertures before the metal foil is set to an upper end of the core 13 such that the resin injected to the rear surface of the metal foil forms the molded part 120 when the molded part 120 is formed and is introduced into the apertures, so that the molded part 120 and the metal part 110 can be integrally formed.

The first mold 11 and the second mold 12 of the injection mold 10 have structures corresponding to the outer appearance of the product on the cavity skin 11a and 12a to form the product, and accordingly, have the above-described structures when the metal part 110 and the molded part 120 are formed in the injection mold 10.

In detail, for example, the second mold 12 has a rounded structure in which a periphery of the metal foil attached to the cavity skin 12a of the second mold 12 is bent to have a curved shape by an injection-molding pressure when the resin is injected to a rear surface of the metal foil, and the second mold 12 has a convexo-concave structure for transferring letters or patterns to the skin of the metal foil.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for forming an interior part of a vehicle, the apparatus comprising:
a first mold forming a cavity when being combined with a second mold;
a core installed in the first mold to be movable forwards and rearwards and configured to approach the second mold when being moved forwards; and
a resin supply line formed in an interior of the core, for supplying a resin into a cavity adjacent to an upper end of the core,
wherein a product in which a metal part and a molded part are integrally formed is formed by setting metal foil which is a material of the metal part to the core, moving the core forwards, and injecting the resin which is a material of the molded part to a rear surface of the metal foil.

2. The apparatus of claim 1, wherein a vacuum supply line for transferring external vacuum to an upper end of the core is formed in the core to prevent separation of the metal foil held at the upper end of the core

3. The apparatus of claim 1, wherein a setting guide formed at a portion adjacent to a periphery of the core at a height higher than an upper end of the core is provided in the first mold such that the metal foil held at the upper end of the core is located at a proper location.

4. The apparatus of claim 1, wherein the second mold has a rounded structure by which a periphery of the metal foil attached to a skin of a cavity of the second mold by an injection-molding pressure when the resin is injection-molded.

5. The apparatus of claim 1, wherein the second mold has a convexo-concave structure for transferring a predetermined shape to a skin of the metal foil.

6. A method of forming an interior part of a vehicle, the apparatus comprising:
a first step of setting metal foil cut to a predetermined size to an upper end of a core of a first mold;
a second step of primarily forming the metal foil by combining the first mold and a second mold and moving the core forwards toward the second mold; and
a third step of supplying a resin to a rear surface of the metal foil and moving the core rearwards to form a molded part in a cavity between the first mold and the second mold and attaching the metal foil to a cavity skin of the second mold by an injection molding pressure of the resin to secondarily form the metal part,
wherein the molded part is integrally formed on a rear surface of the metal part.

7. The method of claim 6, wherein in the first step, the metal foil held at an upper end of the core is prevented from being separated when the core is moved forwards by transferring external vacuum to the rear surface of the metal foil through a vacuum supply line of the core.

8. The method of claim 6, wherein in the first step, the metal foil held at an upper end of the core is located at a proper location through a setting guide of the first mold formed at a height higher than an upper end of the core.

9. The method of claim 6, wherein in the third step, a periphery of the metal foil is attached to the cavity skin of the second mold to be bent to have a curved shape.

10. An interior part of a vehicle, comprising:
a metal part and a molded part integrally formed with a rear surface of the metal part, wherein a periphery of the metal part is bent along a curved shape of a groove recessed between a central portion and a side portion of the molded part and is attached to a surface of the groove.

11. The interior part of claim 10, wherein the metal part has a stamp having a predetermined shape on a skin thereof.
